(19) United States
(12) Patent Application Publication
(10) Pub. No.: US 2017/0279786 A1
(43) Pub. Date: Sep. 28, 2017

(54) SYSTEMS AND METHODS TO PROTECT SENSITIVE INFORMATION IN DATA EXCHANGE AND AGGREGATION

(71) Applicant: DATA REPUBLIC PTY LTD, Sydney (AU)

(72) Inventors: Ryan Matthew Peterson, Discovery Bay, CA (US); Juan Luis Delard de Rigoulieres Mantelli, Rose Bay (AU); Daniel James Gilligan, Erskineville (AU); Simon Nevile Cant, Coogee (AU); Paul Milton McCarney, Clontarf (AU)

(21) Appl. No.: 15/078,804

(22) Filed: Mar. 23, 2016

(51) Int. Cl. H04L 29/06; G06F 17/30

(52) U.S. Cl. CPC H04L 63/08; G06F 17/30312; G06F 17/30867

(57) ABSTRACT

Systems and methods to store, exchange, and aggregate data in association tokens representative of personally identifiable information (PII) without revealing the PII to users of the data. The PII is secured in a centralized location for association with the tokens but without the associated data. Data records are stored in data sources in association with tokens representing the PII but without the PII. Before providing a set of data records from the data sources to a user, a master token is identified based on the data stored in the centralized location to represent a plurality of tokens used in the data records to represent a same person/entity; and the plurality of tokens are replaced with the master token for the data records to link together the data records of the same person/entity.

### FIELD OF THE TECHNOLOGY

At least some embodiments disclosed herein relate to data storage and retrieval in general and more particularly but not limited to protection of identity information in data storage and retrieval.

### BACKGROUND

Personally identifiable information (PII) is data that could potentially identify a specific individual. Information that can be used to distinguish one person from another and can be used for de-anonymizing anonymous data may be considered PII. PII can be used on its own or with other information to identify, contact, or locate a single person, or to identify an individual in context. From PII the identity of a corresponding person can be reasonably ascertainable.

Examples of PII include full name, home address, email address, national identification number, passport number, driver's license number, telephone number, credit card numbers, digital identity, IP address, login name, screen name, nickname, date of birth, birthplace, genetic information, facial image, fingerprints, or handwriting.

There is a need to protect PII for privacy, anonymity, and/or compliance with rules, laws and regulations.

U.S. Pat. No. 7,933,841 discloses a system to track member consumer credit card transactions without receiving personal information for non-members by using a one way hash function. In such a system, a one-way hash function is applied to personal information (e.g., a credit card number) to obtain fingerprints that represent the personal information. The personal information in transaction data of credit card users is replaced by the fingerprints, where some of the users are members and some of the users are non-members. A computer having the personal information of the members can used the personal information to generate the corresponding fingerprints to identify the transactions of the members without access to the personal information of the non-members. The one way hash function makes it nearly impossible to reverse the fingerprints to the corresponding personal information that the computer does not already have.

### BRIEF DESCRIPTION OF THE DRAWINGS

The embodiments are illustrated by way of example and not limitation in the figures of the accompanying drawings in which like references indicate similar elements.

FIG. 1 shows a system to protect identification information in data exchange and aggregation according to one embodiment.

FIG. 2 shows a method to generate de-personalized data according to one embodiment.

FIG. 3 shows a method to tokenize identification information according to one embodiment.

FIG. 4 shows a method to aggregate data according to identity according to one embodiment.

FIG. 5 shows a data processing system that can be used to implement some of the components of the system according to one embodiment.

### DETAILED DESCRIPTION

The following description and drawings are illustrative and are not to be construed as limiting. Numerous specific details are described to provide a thorough understanding. However, in certain instances, well known or conventional details are not described in order to avoid obscuring the description. References to one or an embodiment in the present disclosure are not necessarily references to the same embodiment; and, such references mean at least one.

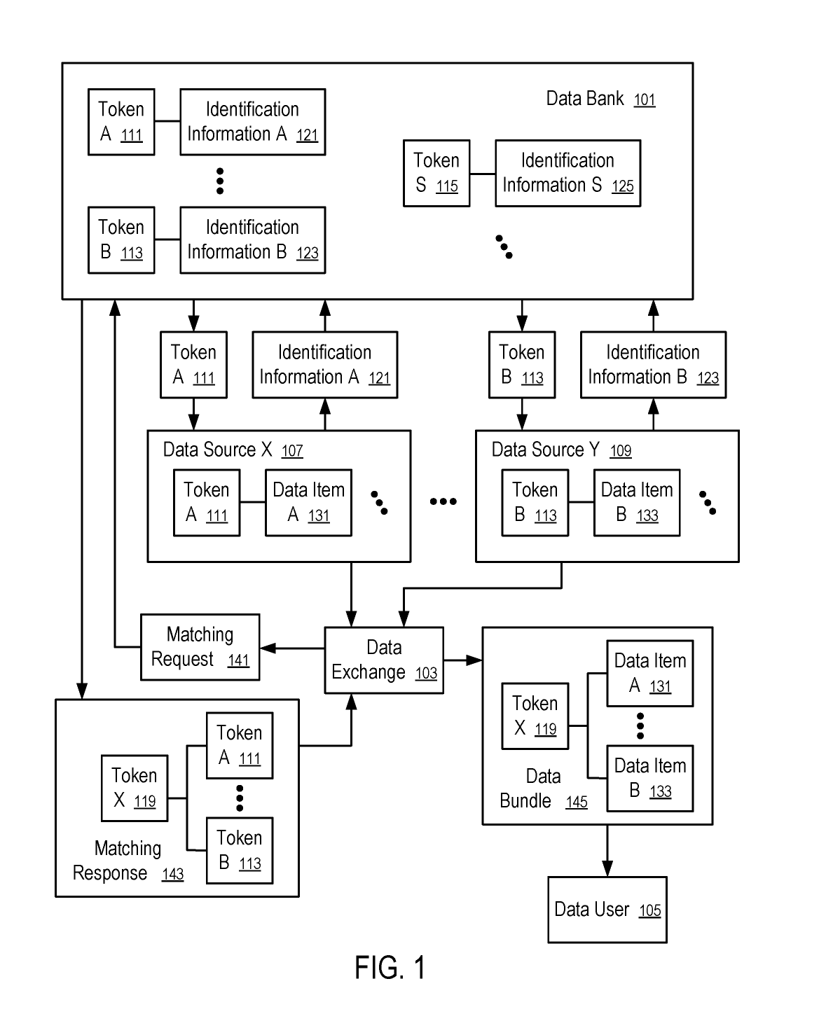

FIG. 1 shows a system to protect identification information in data exchange and aggregation according to one embodiment.

The system in FIG. 1 includes a data bank (101), a data exchange (103), and a plurality of data sources (107, . . . , 109).

In FIG. 1, the data sources (107, . . . , 109) are configured to store de-personalized data that uses a token (e.g., 111 or 113) to represent the identification information (e.g., 121, or 123).

Examples of identification information (e.g., 121, or 123) include personally identifiable information (PII) and other sensitive information.

In FIG. 1, the data sources (107, . . . , 109) do not store the identification information (e.g., 121, or 123) that can be used to determine the identity of an entity (e.g., a person, an organization, a company). The data sources (107, . . . , 109) delegate the task of storing the identification information (e.g., 121, or 123) to the centralized data bank (101), which assigns tokens (111, . . . , 113, . . . , 115) to represent pieces of identification information (121, . . . , 123, . . . , 125) received from the data sources (107, . . . , 109).

For example, after obtaining the identification information A (121) that identifies a person/entity, the data source X (107) submits the identification information A (121) to the data bank (101). In response the data bank (101) assigns a token A (111) to represent the identification information A (121), stores data associating the token A (111) and the identification information A (121), and provides the token A (111) to the data source X (107) as a response to receiving the identification information A (121). Thus, the data source X (107) stores data items (e.g., 131) in association with the token A (111) to indicate the association between the data items (e.g., 131) and the identification information A (121).

In one embodiment, each piece of identification information (e.g., 121, or 123) received from a separate request from a data source (e.g., 107, . . . , or 109) is assigned a separate token (111, or 113). The same identification information submitted by different data sources (e.g., 107, . . . , 109) can be assigned different tokens. Further, the same identification information submitted by the data sources (e.g., 107, . . . , or 109) in different requests for tokens can be assigned different tokens. Thus, the same identification information can be represented in the same data source (107, . . . , or 109) and/or different data sources (107, . . . , 109) by different tokens (e.g., 111, . . . , 113, . . . , 115).

In FIG. 1, the data bank (101) stores the identification information (121, . . . , 123, . . . , 125) but not the data items (e.g., 131, . . . , 133) associated with the identification information (121, . . . , 123, . . . , 125); and the data sources (107, . . . , 109) store the data items (e.g., 131, . . . , 133) without the identification information (121, . . . , 123, . . . , 125). Thus, the risk of revealing information that can be linked to individual persons/entities is reduced, even when the security of one of the data storage component is compromised. Further, using different tokens to represent the same person/entity in different data sources and/or for different data items within a data source reduces the risk of data items being linked to identify the person/entity in unauthorized use of the data.

In one embodiment, the data bank (101) is a highly secured facility that prevents unauthorized access. Thus, the data security of the entire system in protecting the identification information (121, . . . , 123, . . . , 125) is improved.

In FIG. 1, the data exchange (103) is configured to provide data aggregation service to authorized data users (e.g., 105). The data exchange (103) is configured to link the date items (e.g., 131, . . . , 133) associated with different tokens (e.g., 111, . . . , 113) representing the same person/entity for the data user (105).

For example, the data exchange (141) transmits a token matching request (141) to the data bank (101). In response, the data bank (101) identifies, based on the identification information (121, . . . , 123, . . . , 125) stored in the data bank (101), a set of tokens (e.g., 111, . . . , 113) are assigned to represent the same person/entity and assigns a token (119) to represent the set of identified tokens (e.g., 111, . . . , 113) of the same person/entity. The data exchange (103) than replaces, in the data records retrieved from the data sources (107, . . . , 109), the identified tokens (e.g., 111, . . . , 113) of the same person/entity with the token (119) provided in the matching response (143). In such a way the data exchange (103) generates, for the data user (105), a data bundle (145) that links the data items (131, . . . , 133) with the same token (119) representing the different tokens (111, . . . , 113) used in the data sources (107, . . . , 109) to represent the person/entity. Thus, the data items of the person/entity across the data sources (107, . . . , 109) are aggregated according to the identities of the persons/entities, without revealing the identification information (121, . . . , 123, . . . , 125) outside the data bank (101).

Different tokens (e.g., 119) can be used represent the same set of tokens (111, . . . , 123) of a person/entity in data bundles (e.g., 145) provided to different data users (e.g., 105) and/or to the same data user (105) for different data using projections for enhanced identity protection.

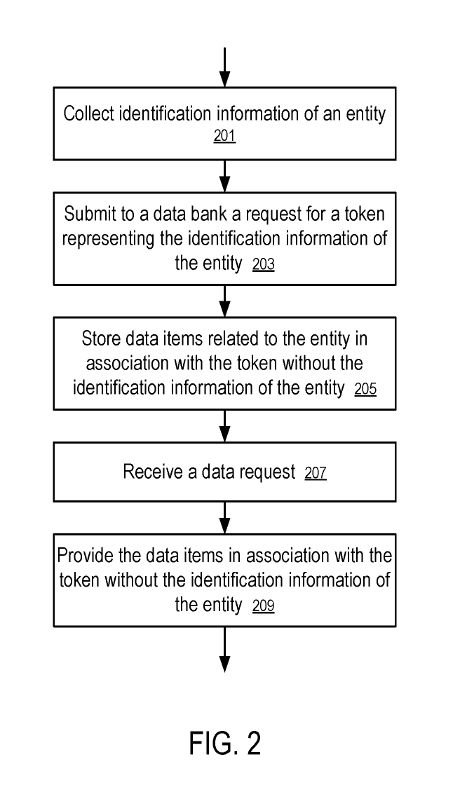

FIG. 2 shows a method to generate de-personalized data according to one embodiment. For example, the method of FIG. 2 can be implemented in a data source (107, . . . , or 109) illustrated in FIG. 1.

In FIG. 2, a computing device (e.g., 107, or 109) is configured to: collect (201) identification information (e.g., 121 or 123) of an entity (e.g., a person, an organization); submit (203) to a data bank (101) a request for a token (e.g., 111 or 113) representing the identification information (e.g., 121, or 123) of the entity; store (205) data items (e.g., 131 or 133) related to the entity in association with the token (e.g., 111 or 113) without the identification information of the entity; receive (207) a data request; and provide (209) the data items (e.g., 131 or 133) in association with the token (e.g., 111 or 113) without the identification information (e.g., 121 or 123) of the entity.

For example, the same entity can be represented by different tokens (e.g., 111, 113) in different data sources (e.g., 107, 119). Further, the same entity associated with different data items in a same data source can be represented by different tokens. Thus, privacy of the entities involved in the data items stored in the data sources (e.g., 107, 119) is improved.

In one embodiment, a data source (e.g., 107 or 109) does not store the identification information (e.g., 121 or 123) that is represented by the respective tokens (e.g., 111 or 113). Thus, the damage of a data breach in the data source (e.g., 107 or 109) is limited.

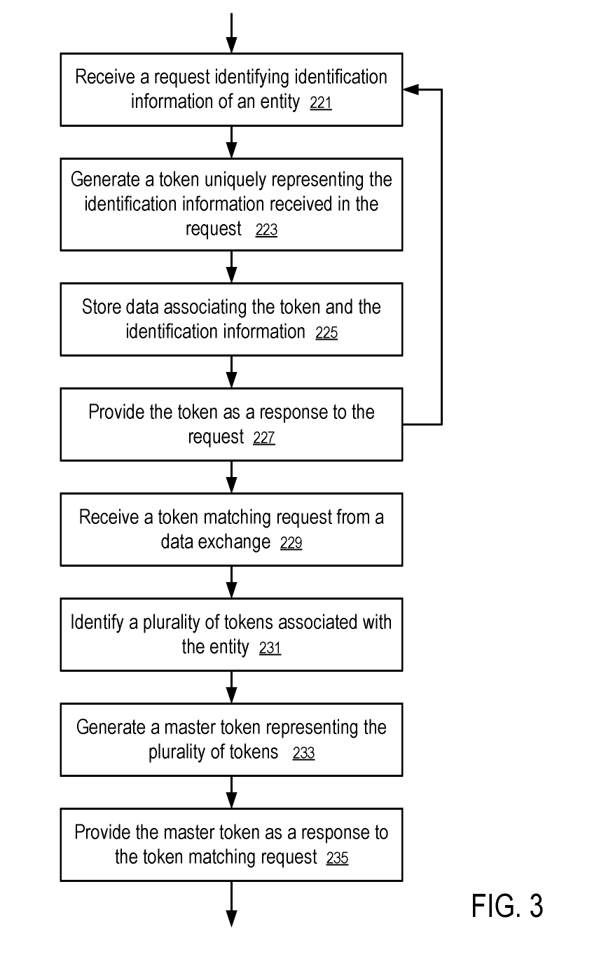

FIG. 3 shows a method to tokenize identification information according to one embodiment. For example, the method of FIG. 3 can be implemented in a data bank (101) illustrated in FIG. 1.

In FIG. 3, a computing device (e.g., 101) is configured to: receive (221) a request identifying identification information (e.g., 121 or 123) of an entity; generate (223) a token (e.g., 111 or 113) uniquely representing the identification information (e.g., 121 or 123) received in the request; store (225) data associating the token (e.g., 111 or 113) and the identification information (e.g., 121 or 123); provide (227) the token (e.g., 111 or 113) as a response to the request such that association between data items (e.g., 131 or 133) and the entity identified by the identification information (e.g., 121 or 123) can be represented by association between the data items (e.g., 131 or 133) and the tokens (e.g., 111 or 113) without the need to store the identification information (e.g., 121 or 123) in data sources (e.g., 107 or 109); receive (229) a token matching request (141) from a data exchange (103); identify (231) a plurality of tokens (e.g., 111 . . . , 113) associated with the entity based on the identification information (e.g., 121, . . . , 123) stored in the computing device (e.g., 101); generate (233) a master token (e.g., 119) representing the plurality of tokens (e.g., 111, . . . , 113); and provide (235) the master token (e.g., 119) as a response to the token matching request (141) to allow the recipient to link data items (e.g., 131, . . . , 133) that are associated with the different tokens (e.g., 111, . . . , 113) in the data sources (e.g., 107, . . . , 109) with the same master token (119) that represents the entity without revealing any of the identification information (e.g., 121, . . . , 123) of the entity.

The tokens (e.g., 121, . . . , 123, . . . , 125) are generated in a way that cannot be reversed to reveal the identification information (e.g., 121, . . . , 123, . . . , 125) represented by the respective tokens (e.g., 121, . . . , 123, . . . , 125). For example, the tokens (e.g., 121, . . . , 123, . . . , 125) can be selected from random numbers generated by the data bank (101). Alternatively or in combination, the tokens (e.g., 121, . . . , 123, . . . , 125) can be selected further based on the identification information (e.g., 121, . . . , 123, . . . , 125) and/or the requests for tokens. For example, the token (111) can be computed from a one-way hash of a combination of the identification information (121), a random number, an identification of the data source (107) that submits the identification information (121) to obtain the token (111), the date and/or time of the request for the token (111), and/or the date and/or time of the generation of the token (111), etc.

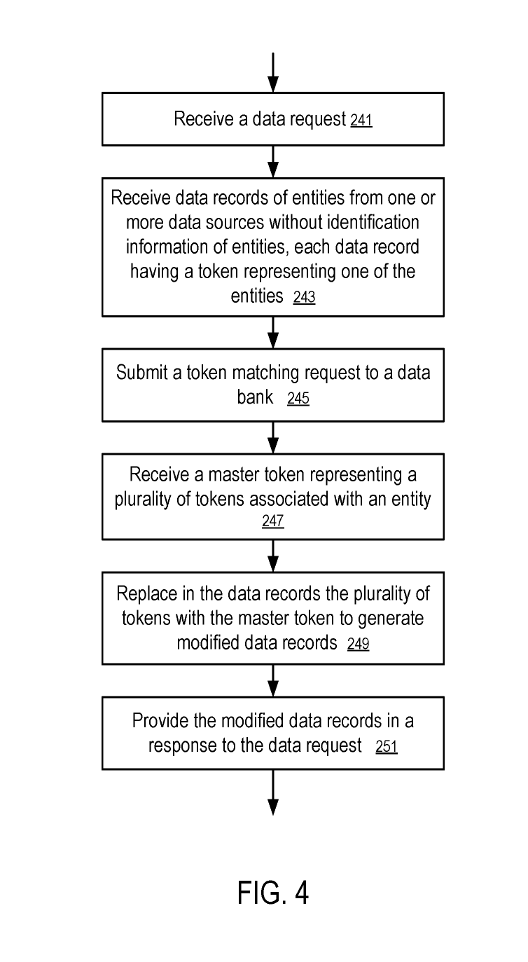

FIG. 4 shows a method to aggregate data according to identity according to one embodiment. For example, the method of FIG. 4 can be implemented in the data exchange (103) illustrated in FIG. 1.

In FIG. 4, a computing device (e.g., 103) is configured to: receive (241) a data request (e.g., from a data user (105) over a data communication network), receive (243) data records of entities from one or more data sources (e.g., 107, 109) without identification information of entities, where each data record has a token (e.g., 111 or 113) representing one of the entities; submit (245) a token matching request (141) to a data bank (101) that stores data associating tokens (e.g., 111, . . . , 113, . . . , 115) and identification information (e.g., 121, . . . , 123, . . . , 125); receive (247) a master token (119) representing a plurality of tokens (e.g., 111, 113) associated with an entity; replace (249) in the data records the plurality of tokens (e.g., 111, 113) with the master token (119) to generate modified data records (e.g., data bundle (145)); and provide (251) the modified data records in a response to the data request.

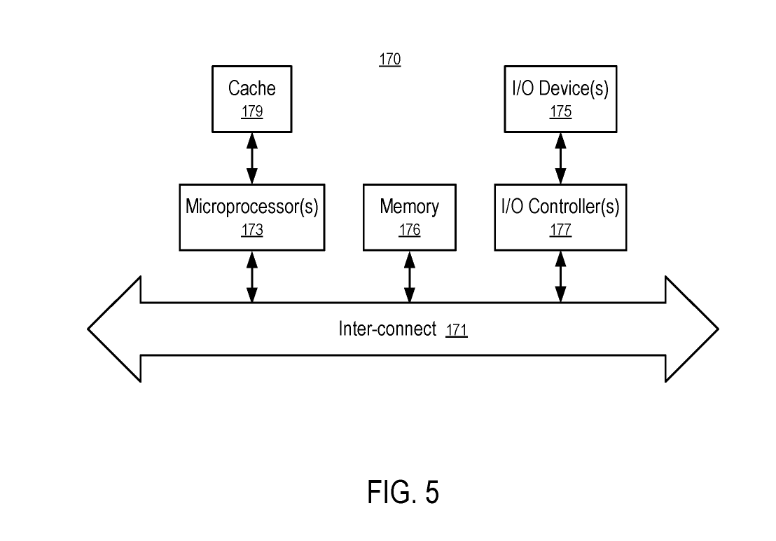

FIG. 5 shows a data processing system that can be used to implement some of the components of the system according to one embodiment. While FIG. 5 illustrates various components of a computer system, it is not intended to limit the implementations to any particular architecture or manner of interconnecting the components. One embodiment may use other systems that have fewer or more components than those shown in FIG. 5.

For example, the data exchange (103) illustrated in FIG. 1 can be implemented using one or more data processing systems illustrated in FIG. 5, with fewer or more components than those shown in FIG. 5.

For example, a data source (e.g., 107 or 109) illustrated in FIG. 1 can be implemented using one or more data processing systems illustrated in FIG. 5, with fewer or more components than those shown in FIG. 5.

For example, the data bank (101) illustrated in FIG. 1 can be implemented using one or more data processing systems illustrated in FIG. 5, with fewer or more components than those shown in FIG. 5.

In FIG. 5, the data processing system (170) includes an inter-connect (171) (e.g., bus and system core logic), which interconnects a microprocessor(s) (173) and memory (176). The microprocessor (173) is coupled to cache memory (179) in the example of FIG. 5.

In one embodiment, the inter-connect (171) interconnects the microprocessor(s) (173) and the memory (176) together and also interconnects them to input/output (I/O) device(s) (175) via I/O controller(s) (177). I/O devices (175) may include a display device and/or peripheral devices, such as mice, keyboards, modems, network interfaces, printers, scanners, video cameras and other devices known in the art. In one embodiment, when the data processing system is a server system, some of the I/O devices (175), such as printers, scanners, mice, and/or keyboards, are optional.

In one embodiment, the inter-connect (171) includes one or more buses connected to one another through various bridges, controllers and/or adapters. In one embodiment the I/O controllers (177) include a USB (Universal Serial Bus) adapter for controlling USB peripherals, and/or an IEEE-1394 bus adapter for controlling IEEE-1394 peripherals.

In one embodiment, the memory (176) includes one or more of: ROM (Read Only Memory), volatile RAM (Random Access Memory), and non-volatile memory, such as hard drive, flash memory, etc.

Volatile RAM is typically implemented as dynamic RAM (DRAM) which requires power continually in order to refresh or maintain the data in the memory. Non-volatile memory is typically a magnetic hard drive, a magnetic optical drive, an optical drive (e.g., a DVD RAM), or other type of memory system which maintains data even after power is removed from the system. The non-volatile memory may also be a random access memory.

The non-volatile memory can be a local device coupled directly to the rest of the components in the data processing system. A non-volatile memory that is remote from the system, such as a network storage device coupled to the data processing system through a network interface such as a modem or Ethernet interface, can also be used.

In this description, some functions and operations are described as being performed by or caused by software code to simplify description. However, such expressions are also used to specify that the functions result from execution of the code/instructions by a processor, such as a microprocessor.

Alternatively, or in combination, the functions and operations as described here can be implemented using special purpose circuitry, with or without software instructions, such as using Application-Specific Integrated Circuit (ASIC) or Field-Programmable Gate Array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

While one embodiment can be implemented in fully functioning computers and computer systems, various embodiments are capable of being distributed as a computing product in a variety of forms and are capable of being applied regardless of the particular type of machine or computer-readable media used to actually effect the distribution.

At least some aspects disclosed can be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device.

Routines executed to implement the embodiments may be implemented as part of an operating system or a specific application, component, program, object, module or sequence of instructions referred to as “computer programs.” The computer programs typically include one or more instructions set at various times in various memory and storage devices in a computer, and that, when read and executed by one or more processors in a computer, cause the computer to perform operations necessary to execute elements involving the various aspects.

A machine readable medium can be used to store software and data which when executed by a data processing system causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or peer to peer networks. Different portions of the data and instructions can be obtained from different centralized servers and/or peer to peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a machine readable medium in entirety at a particular instance of time.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks (DVDs), etc.), among others. The computer-readable media may store the instructions.

The instructions may also be embodied in digital and analog communication links for electrical, optical, acoustical or other forms of propagated signals, such as carrier waves, infrared signals, digital signals, etc. However, propagated signals, such as carrier waves, infrared signals, digital signals, etc. are not tangible machine readable medium and are not configured to store instructions.

In general, a machine readable medium includes any mechanism that provides (i.e., stores and/or transmits) information in a form accessible by a machine (e.g., a computer, network device, personal digital assistant, manufacturing tool, any device with a set of one or more processors, etc.).

In various embodiments, hardwired circuitry may be used in combination with software instructions to implement the techniques. Thus, the techniques are neither limited to any specific combination of hardware circuitry and software nor to any particular source for the instructions executed by the data processing system.

The description and drawings are illustrative and are not to be construed as limiting. The present disclosure is illustrative of inventive features to enable a person skilled in the art to make and use the techniques. Various features, as described herein, should be used in compliance with all current and future rules, laws and regulations related to privacy, security, permission, consent, authorization, and others. Numerous specific details are described to provide a thorough understanding. However, in certain instances, well known or conventional details are not described in order to avoid obscuring the description. References to one or an embodiment in the present disclosure are not necessarily references to the same embodiment; and, such references mean at least one.

The use of headings herein is merely provided for ease of reference, and shall not be interpreted in any way to limit this disclosure or the following claims.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, and are not necessarily all referring to separate or alternative embodiments mutually exclusive of other embodiments. Moreover, various features are described which may be exhibited by one embodiment and not by others. Similarly, various requirements are described which may be requirements for one embodiment but not other embodiments. Unless excluded by explicit description and/or apparent incompatibility, any combination of various features described in this description is also included here. For example, the features described above in connection with “in one embodiment” or “in some embodiments” can be all optionally included in one implementation, except where the dependency of certain features on other features, as apparent from the description, may limit the options of excluding selected features from the implementation, and incompatibility of certain features with other features, as apparent from the description, may limit the options of including selected features together in the implementation.

The disclosures of the above discussed patent documents are hereby incorporated herein by reference.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

What is claimed is:

1. A non-transitory computer storage medium storing instructions configured to instruct a computing apparatus to perform a method in a data communication network, the method comprising:
receiving, in a data exchange over the data communication network, a request for data;
retrieving, by the data exchange from a plurality of separate data sources over the data communication network, a set of data records, each data record in the set of data records comprising
a token representing a set of identification data of a person stored in a data bank, wherein
the data sources separately submit sets of identification data of entities to the data bank to receive tokens representing the sets of identification data,
the data bank assigns different tokens for the corresponding sets of identification data received from the data sources, and
the data bank stores data associating the tokens with the corresponding sets of identification data; and
a data item associated with the token representing the set of identification data of the person, wherein the set of data records has a plurality of different tokens, the data bank stores the identification data but not the data item, and the data sources store the data item but not the identification data;
transmitting, by the data exchange over the data communication network, a matching request to the data bank, wherein in response to the matching request, the data bank identifies, from the data associating the tokens with the corresponding sets of identification data, a set of tokens having matching sets of identification data of a same first person and assigns a first token representing the set of tokens;
receiving, in the data exchange over the data communication network from the data bank as a response to the matching request, the first token representing the set of tokens;
generating, by the data exchange, a revised set of data records from the set of data records by replacing
association of respective data items with tokens in the set, with
association of the respective data items with the first token; and
providing, by the data exchange over the data communication network, a response to the request for data based on the revised set of data records.

2. A method, comprising:
receiving, in a computing apparatus, a data request;
retrieving, by the computing apparatus, a set of data records, wherein each of the data records includes an data item and a token representative a piece of identification information not provided in the data records;
determining, by the computing apparatus, a first token representative a plurality of second tokens in the data records, wherein the second tokens are determined to represent pieces of identification information that are related to each other;
replacing, by the computing apparatus, the second tokens with the first token in the data records to generate revised data records; and
providing, by the computing apparatus, the revised data records as a response to the data request.

3. The method of claim 2, wherein the second tokens represent the pieces of identification information of a same person.

4. The method of claim 3, wherein the data records are retrieved from a plurality of data sources.

5. The method of claim 4, wherein the plurality of data sources are configured to store the data records without storing the pieces of identification information

6. The method of claim 4, wherein the plurality of second tokens are used in the plurality of data sources to represent same identification information of the same person. The method of claim 4, wherein the plurality of second tokens are used in the plurality of data sources to represent different pieces of identification information of the same person.

8. The method of claim 4, further comprising:
receiving from each of the plurality of data sources a piece of identification of the same person;
assigning a corresponding one of the second tokens to the piece of identification information of the same person received from a respective one of the data sources; and
storing data associating the second tokens with respective pieces of identification information received from the plurality of data sources.

9. The method of claim 8, further comprising:
correlating the respective pieces of identification information as being for the same person; and
assigning the first token to represent the second tokens.

10. The method of claim 8, wherein the data associating the second tokens with respective pieces of identification information received from the plurality of data sources is stored in a centralized location remote from the computing apparatus.

11. The method of claim 2, wherein the pieces of identification information represented by the second tokens are not derivable from the revised data records.

12. A computing apparatus, comprising:
at least one communication interface;
at least one microprocessor; and
a memory storing instructions configured to instruct the at least one microprocessor to:
receive, via the at least one communication interface, a data request;
retrieve, via the at least one communication interface, a set of data records, wherein each of the data records includes an data item and a token representative a piece of identification information not provided in the data records;
determine a first token representative a plurality of second tokens in the data records, wherein pieces of identification information represented by the second tokens respectively are determined to be related to each other;
replace the second tokens with the first token in the data records to generate revised data records; and
provide, via the at least one communication interface, the revised data records as a response to the data request.

13. The computing apparatus of claim 12, wherein the pieces of identification information represented by the second tokens respectively are determined to be related to each other for identifying a same entity.

14. The computing apparatus of claim 13, wherein the data records are retrieved over a network from a plurality of separate data sources.

15. The computing apparatus of claim 14, wherein the plurality of data sources are configured to store the data records without storing the pieces of identification information represented by the second tokens.

16. The computing apparatus of claim 14, wherein the pieces of identification information represented by the second tokens match with each other in identifying the same entity.

17. The computing apparatus of claim 16, wherein the entity is a person; and the pieces of identification information represented by the second tokens are personally identifiable information.

18. The computing apparatus of claim 14, further comprising:
a centralized data storage apparatus configured to:
receive from each of the plurality of data sources a piece of identification of the same entity;
assign a corresponding one of the second tokens to the piece of identification information of the same entity received from a respective one of the data sources; and
store data associating the second tokens with respective pieces of identification information received from the plurality of data sources.

19. The computing apparatus of claim 18, wherein the centralized data storage apparatus is further configured to:
receive a token matching request;
match the respective pieces of identification information as identifying the same entity;
assign the first token to represent the second tokens; and
provide the first token in a response for the token matching request.

20. The computing apparatus of claim 18, wherein the data associating the second tokens with respective pieces of identification information received from the plurality of data sources is stored in a centralized location remote from the computing apparatus.
